(19) United States
(12) Patent Application Publication
(10) Pub. No.: US 2026/0140478 A1
(43) Pub. Date: May 21, 2026

(54) HOROLOGY MOVEMENT COMPRISING A POWER RESERVE DISPLAY DEVICE

(71) Applicant: Montres Breguet S.A., L'Abbaye (CH)

(72) Inventor: Pascal FRIDERICI, L'Orient (CH)

(73) Assignee: Montres Breguet S.A., L'Abbaye (CH)

(21) Appl. No.: 19/312,750

(22) Filed: Aug. 28, 2025

(30) Foreign Application Priority Data
Nov. 19, 2024 (EP) 24213824.6

(51) Int. Cl. G04B 9/00; G04B 13/00

(52) U.S. Cl. CPC G04B 9/005; G04B 13/008

(57) ABSTRACT

A horology movement including at least one barrel (11, 12) and a device for displaying a power reserve (10). The device includes: a winding mechanism including a winding train (15); a reduction train (16) meshing with the or one of the barrels (11; 12); a differential gear (14) arranged so as to kinematically join the winding train (15) and the barrel (11) via a first entry on the differential gear (14), the differential gear (14) including a second entry by which it is joined to the reduction train (16), and including an exit, the first and the second entry and exit on the differential gear (14) being coaxial; and a power reserve display module (17) engaging with the exit on the differential gear (14).

### CROSS REFERENCE TO RELATED APPLICATIONS

This application claims priority to European Patent Application No. 24213824.6 filed Nov. 19, 2024, the entire contents of which are incorporated herein by reference.

### TECHNICAL FIELD OF THE INVENTION

The invention relates to the field of horology and, in particular, to a horology movement comprising a device for displaying a power reserve.

### TECHNOLOGICAL BACKGROUND

In a horology movement, a power reserve display device is a horological complication that enables a user to know the level of energy available for displaying the hour or any other time indication. In other words, a power reserve display device makes it possible to indicate the charge level of the barrel(s) in the horology movement.

A power reserve display device comprises a power reserve indicator, such as a hand, and a differential gear joining the indicator to the barrel(s), as described in document EP3333637.

Power reserve display devices generally comprise numerous components so as to display adequate reduction ratios between the barrel(s) in the horology movement and the power reserve indicator. These numerous components significantly impact the cost of the horology movements in which they are incorporated. Moreover, power reserve display devices are relatively bulky, making them difficult to incorporate into a horology movement.

### SUMMARY OF THE INVENTION

The invention remedies the aforementioned drawbacks by providing a horology movement comprising at least one barrel and a device for displaying the power reserve.

Said power reserve display device comprises:
a winding mechanism comprising a winding train,
a reduction train meshing with the or one of the barrels,
a differential gear arranged so as to kinematically join the winding train and the barrel via a first entry on the differential gear, said differential gear comprising a second entry by which it is joined to the reduction train, and comprising an exit, the first and the second entry and exit on the differential gear being coaxial,
a power reserve display module engaging with the exit on the differential gear.

These characteristics advantageously reduce the number of components in the power reserve display device and thereby its overall volume.

In particular embodiments, the invention can further comprise one or more of the following features, taken separately or in any technically possible combination.

In particular embodiments, the differential gear comprises a satellite carried by a satellite carrier wheel rotationally secured to an axis, the satellite carrier wheel constituting the first entry on the differential gear and comprising external toothing by which it meshes with the barrel and with the winding mechanism.

In particular embodiments, the second differential gear entry consists of a solar wheel mounted so as to be rotationally mobile on the axis.

In particular embodiments, the differential gear comprises a crown rotationally secured by friction to a pipe constituting the exit on the differential gear, the latter being hafted so as to be rotationally mobile on the axis, said crown having internal toothing by which it is kinematically joined to the satellite, preferentially via an intermediate wheel carried by the satellite carrier wheel and meshing with the satellite.

In particular embodiments, the power reserve display module comprises an index cam secured to the pipe, a feeler spindle arranged to bear against the latter and a power reserve indicator joined to the feeler spindle such that the movement of the cam drives the movement of the power reserve indicator.

In particular embodiments, the horology movement comprises a first and a second barrel each comprising a ratchet wheel, both meshing with a drive wheel, the first barrel comprising a drum joining it to the differential gear and the second barrel comprising a drum joining it to the reduction train.

### BRIEF DESCRIPTION OF THE FIGURES

Other features and advantages of the invention will become apparent from the following detailed description, given by way of non-limiting example, with reference to the attached drawings in which:

FIG. 1 shows a perspective view from below of two barrels and of a device for displaying the power reserve in a horology movement according to a preferred exemplary embodiment of the invention,

FIG. 2 shows a cross-sectional view of a differential gear on the power reserve display device in FIG. 1,

FIG. 3 shows a top view of the differential gear engaging with a power reserve display module,

FIG. 4 shows a perspective view from below of a barrel and of a power reserve display device in a horology movement according to another exemplary embodiment of the invention.

It should be noted that the figures are not necessarily drawn to scale for clarity reasons.

### DETAILED DESCRIPTION OF THE INVENTION

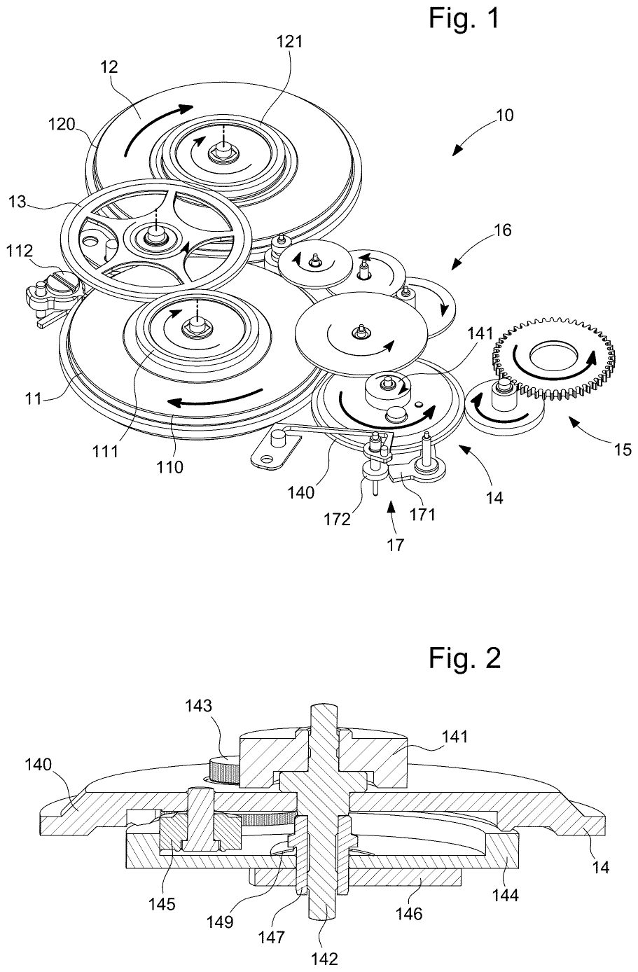

FIG. 1 shows two barrels and a device for displaying the power reserve 10 in a horology movement according to a preferred exemplary embodiment of the invention.

As can be seen in FIG. 1, the horology movement according to the invention comprises a first barrel 11 and a second barrel 12 kinematically joined to each other by a drive wheel 13 and each comprising a barrel spring, in a manner known per se to persons skilled in the art.

More specifically, the first and second barrels 11 and 12 each comprise a drum 110 and 120 and a ratchet wheel 111 and 121 both preferentially meshing with the drive wheel 13.

The drum 110 on the first barrel 11 engages with a click 112 such that said drum 110 is rotationally locked in one direction by the effect of the click, with only the ratchet wheel 111 rotating under the effect of the let-down of the barrel spring. The spring in the second barrel 12 is also let down when the horology movement is running in a manner known per se and rotates a finishing train (not shown in the figures) via the drum 120. These rotations are symbolised by the arrows in regular font in FIG. 1.

The power reserve display device 10 comprises a differential gear 14 kinematically inserted between a winding train 15 on a winding mechanism and the first barrel 11. In other words, the differential gear 14 is arranged so as to kinematically join the winding train 15 and the first barrel 11. The winding mechanism 15 is preferentially constituted by only two rotationally secure mobile parts, as can be seen in FIG. 1.

The winding mechanism can be acted upon via a winding crown joined to a winding stem, and/or via an oscillating mass. The winding mechanism is known per se to the person skilled in the art and is therefore not described in further detail below.

In particular, the differential gear 14 engages with the winding mechanism 15 and with the drum 110 on the first barrel 11 via a first entry which, in the exemplary embodiment of the invention shown in FIGS. 1 and 2, consists of a satellite carrier wheel 140.

The springs in the first and second barrels 11 and 12 are thus wound when the drum 110 on the first barrel 11 is driven by the satellite carrier wheel 140, in a given direction of rotation, for example clockwise as symbolised by the bolded arrows in FIG. 1, after the winding mechanism 15 has been acted upon in a winding direction. The satellite carrier wheel 140 comprises external toothing for this purpose, which engages with toothing on the drum 110 on the first barrel 11.

The differential gear 14 also comprises a second entry by which it is joined to the second barrel 12 by a reduction train 16. The second entry consists of a solar wheel 141 mounted so as to be rotationally mobile relative to the satellite carrier wheel 140. In particular, the differential gear 14 comprises an axis 142 onto which the satellite carrier wheel 140 is driven and on which the solar wheel 141 is mounted so as to rotate freely, as can be seen in FIG. 2.

As shown in particular in FIG. 2 in an exemplary embodiment of the invention, the solar wheel 141 meshes with a satellite 143 carried by the satellite carrier wheel 140. The differential gear 14 comprises a crown 144 kinematically joined to the satellite 143 preferentially by an intermediate wheel 145 carried so as to rotate freely by the satellite carrier wheel 140. In particular, the intermediate wheel 145 meshes with inner toothing on the crown 144.

More specifically, the satellite 143 preferably comprises a pinion meshing with the solar wheel 141 and a wheel meshing with the intermediate wheel 145.

In the particular exemplary embodiment shown in the figures, the crown 144 is coaxially arranged with the satellite carrier wheel 140 and is rotationally secured by friction with a pipe 147 which is itself rotationally mobile on the axis 142.

The pipe 147 forms the exit on the differential gear 14. Advantageously, the first and second entries and the exit on the differential gear 14 are coaxially arranged with each other, as can be seen in FIG. 2. This characteristic reduces the volume occupied by the differential gear within the horology movement. This particularly compact arrangement makes it possible to reduce the volume required within the horology movement to incorporate the differential gear 14.

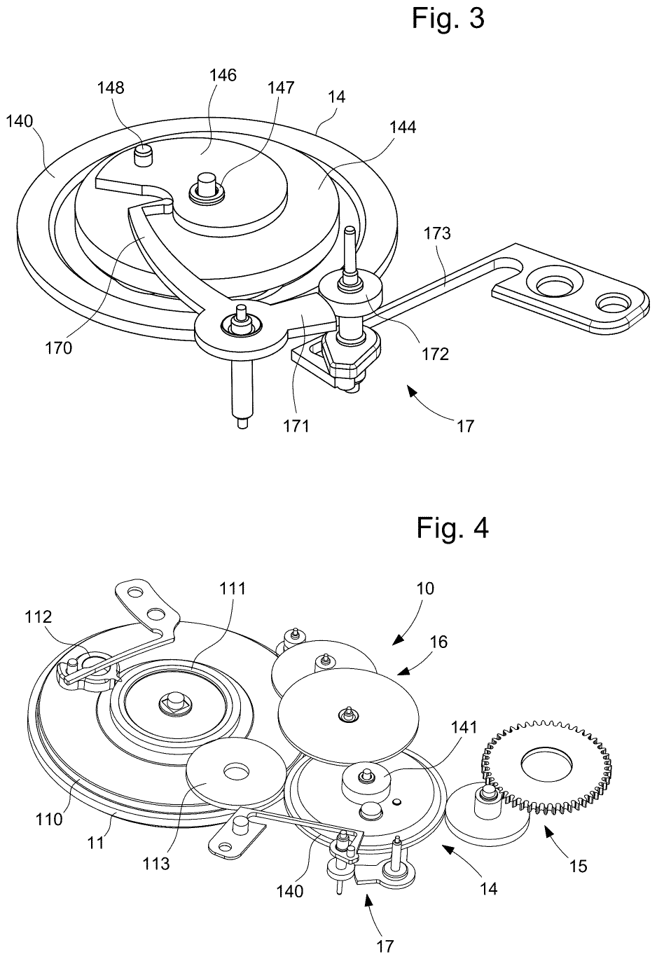

The power reserve display device 10 comprises a power reserve display module 17 engaging with the exit on the differential gear 14, as shown in detail in FIG. 3.

In an exemplary embodiment of the invention not shown in the figures, the power reserve display module 17 comprises an indicator, such as a hand or a disc, secured to the pipe 147, for example by a pivot shank.

In another exemplary embodiment of the invention that can be seen in particular in FIG. 3, the power reserve display module 17 can comprise an index cam 146 driven onto the pipe 147, meaning that it is rotationally secured by friction with the crown 144.

Advantageously, the crown 144 is pressed against the index cam 146 by a friction spring 149, such as a convex or concave washer, held axially as a stop against a radial lip on the pipe 147, as can be seen in the cross-sectional view in FIG. 2. Alternatively, the crown 144 can be formed by a friction wheel (not shown in the figures), and can thus comprise a rim to which two resilient arms are joined at their ends, the resilient arms being arranged relative to each other so as to define a hole in which the pipe 147 is engaged.

In the exemplary embodiment shown in FIG. 3, a peg 148 is secured to the index cam 146 and extends along an axis parallel to the axis 142. When the index cam 146 rotates, the peg 148 is designed to move in a groove provided for this purpose in a structure on the horology movement, for example a bar or a plate. This groove (not shown in the figures) extends in a curvilinear direction centred on the axis 142, between two ends. The peg 148 bears against one of these ends respectively after the springs in the first and second barrels 11 and 12 have been fully wound or fully let down, causing the crown 144 to slide relative to the pipe 147 and to the index cam 146.

In this exemplary embodiment of the invention, the power reserve display module 17 further comprises a rack 171 arranged to bear against the profile of the index cam 146 via a feeler spindle 170, as well as an indicator pinion 172 on which the indicator is secured so as to indicate the power reserve. The indicator pinion 172 meshes with the toothing on the rack 171 such that the movement of the feeler spindle 170 on the profile of the index cam 146 causes it to rotate.

The power reserve display module 17 also comprises a return spring 173 arranged to engage with the indicator pinion 172 so as to restrain the feeler spindle 170 bearing against the profile of the index cam 146 and to make up for any slack in the gearing. As shown in FIGS. 1 and 3, the return spring 173 is arranged in particular so as to bear against a peg secured to a radial lip on the indicator pinion 172.

To sum up, when the winding mechanism 15 is acted upon in the winding direction, symbolised by the bolded arrows in FIG. 1, the drum 110 on the first barrel 11 is rotated by the satellite carrier wheel 140, which is itself rotated by the winding mechanism 15. On the other hand, the satellite carrier wheel 140 drives the satellite 143 and the intermediate wheel 145 in a circular movement centred around the axis 142 of the differential gear 14. It should be noted that when the satellite carrier wheel 140 rotates, the satellite 143 also pivots around its axis as it meshes with the solar wheel 141.

The rotation of the satellite 143 as explained above causes the intermediate wheel 145 to rotate around its axis, thereby rotating the crown 144 and, consequently, the index cam 146. The feeler spindle 170 engaging with the index cam 146 drives the power reserve indicator so as to indicate an increase in the power reserve.

At the same time, the ratchet wheel 121 on the second barrel 12 is rotated by the ratchet wheel 111 on the first barrel 11 via the transmission wheel 13, such that the spring in the second barrel 12 is gradually wound.

Once the spring in the second barrel 12 is sufficiently wound, it rotates the drum 120 on the second barrel 12 so as to release the finishing train and thereby the start the horology movement. The rotation of the drum 120 on the second barrel 12 rotates the solar wheel 141 via the reduction train 16.

Furthermore, when the winding train 15 is not acted upon and the springs in the first and second barrels 11 and 12 are letting down, that is, when the horology movement is running, the drum 120 on the second barrel 12 transmits, via the reduction train 16, a rotational movement to the solar wheel 141, as described above, and the satellite carrier wheel 140 is then fixed. The satellite 143, the intermediate wheel 145, and the crown 144 are rotated around their respective axes. The rotation of the crown 144 frictionally drives the rotation of the index cam 146, which causes the feeler spindle 170 to move so as to drive the power reserve indicator to indicate a decrease in the power reserve.

The arrangement of the differential gear 14 advantageously offers a high reduction ratio between the rotation of the power reserve indicator and that of the drum 110 on the first barrel 11 when the satellite carrier wheel 140 is driven while the springs in the first and second barrels 11 and 12 are winding. By way of example, the power reserve indicator can be driven by a fraction of a turn, for example between 0.1 and 0.2 turns, when the drum 110 on the first barrel 11 is driven by several dozen turns, for example between 25 and 30 turns.

Similarly, while the springs in the first and second barrels 11 and 12 are letting down, due to the reduction train 16 and to the arrangement of the differential gear 14, the drum 120 on the second barrel 12 can make several dozen turns, for example between 25 and 30 turns, and drive the power reserve indicator to make a fraction of a turn, for example between 0.1 and 0.2 turns.

In another exemplary embodiment of the invention shown in the FIG. 4, it could be foreseen that the horology movement according to the invention comprises a single barrel 11 comprising a barrel spring in a manner known per se by the person skilled in the art. The barrel 11 also comprises a drum 110 and a ratchet wheel 111.

In the exemplary embodiment shown in FIG. 4, the ratchet wheel 111 is kinematically joined to the satellite carrier wheel 140 so as to be rotated by the latter when the winding train 15 is acted upon in a winding direction. This characteristic makes it possible to wind the barrel spring 11. In this exemplary embodiment of the invention, an intermediate wheel 113 is inserted between the ratchet wheel 111 and the satellite carrier wheel 140.

Similar to what has been described above, the ratchet wheel 111 engages with a click 112 such that it is rotationally locked by the latter. Then only the drum 110 is rotated under the effect of the let-down of the barrel spring.

The drum 110 is joined to the second entry on the differential gear 14, namely the solar wheel 141, via the reduction train 16.

More generally, it should be noted that the embodiments and uses considered above have been described by way of non-limiting examples, and that other variants are therefore conceivable.

In particular, it is conceivable that the power reserve display module 17 comprises at least one intermediate wheel meshing with a mobile carrying a power reserve indicator so as to shift the power reserve display.

1. A horology movement comprising at least one barrel (11, 12) and a device for displaying a power reserve (10), said device comprising:
a winding mechanism comprising a winding train (15);
a reduction train (16) meshing with the or one of the barrels (11;

12;
a differential gear (14) arranged so as to kinematically join the winding train (15) and the barrel (11) via a first entry on the differential gear (14), said differential gear (14) comprising a second entry by which it is joined to the reduction train (16), and comprising an exit; and
a power reserve display module (17) engaging with the exit on the differential gear (14).

2. The horology movement according to claim 1, wherein the differential gear (14) comprises a satellite (143) carried by a satellite carrier wheel (140) rotationally secured to an axis (142), the satellite carrier wheel (140) constituting the first entry on the differential gear and comprising external toothing by which it meshes with the barrel (11) and with the winding mechanism (15).

3. The horology movement according to claim 2, wherein the second differential gear entry (14) is constituted by a solar wheel (141) mounted so as to be rotationally mobile on the axis (142).

4. The horology movement according to claim 3, wherein the differential gear (14) comprises a crown (144) rotationally secured by friction to a pipe (147) constituting the exit on the differential gear, the latter being hafted so as to be rotationally mobile on the axis (142), said crown (144) having internal toothing by which it is kinematically joined to the satellite (143).

5. The horology movement according to claim 3, wherein the crown (144) is kinematically joined to the satellite (143) via an intermediate wheel (145) carried by the satellite carrier wheel (140) and meshing with the satellite (143).

6. The horology movement according to claim 4, wherein the power reserve display module (17) comprises an index cam (146) secured to the pipe (147), a feeler spindle (170) arranged to bear against the latter and a power reserve indicator joined to the feeler spindle (170) such that the movement of the cam drives the movement of the power reserve indicator.

7. The horology movement according to claim 5, wherein the power reserve display module (17) comprises an index cam (146) secured to the pipe (147), a feeler spindle (170) arranged to bear against the latter and a power reserve indicator joined to the feeler spindle (170) such that the movement of the cam drives the movement of the power reserve indicator.

8. The horology movement according to claim 1, further comprising a first and a second barrel (11, 12) each comprising a ratchet wheel (111, 121), both meshing with a drive wheel (13), the first barrel (11) comprising a drum (110) joining it to the differential gear (14) and the second barrel (12) comprising a drum (120) joining it to the reduction train (16).
